(19) United States
(12) Patent Application Publication
(10) Pub. No.: US 2013/0180353 A1
(43) Pub. Date: Jul. 18, 2013

(54) ROBOT ARM HAVING A WEIGHT COMPENSATION MECHANISM

(71) Applicant: KOREA INSTITUTE OF SCIENCE AND TECHNOLOGY, Seoul (KR)

(72) Inventors: Sung Chul KANG, Seoul (KR); Chang Hyun CHO, Gwangju (KR); Jun Ho CHOI, Seoul (KR); Mun Sang KIM, Seoul (KR)

(73) Assignee: KOREA INSTITUTE OF SCIENCE AND TECHNOLOGY, Seoul (KR)

(21) Appl. No.: 13/741,839

(22) Filed: Jan. 15, 2013

(30) Foreign Application Priority Data
Jan. 17, 2012 (KR) 10-2012-0005264

(51) Int. Cl. B25J 19/00

(52) U.S. Cl. CPC B25J 19/0008
USPC 74/490.04

(57) ABSTRACT

The robot arm having a weight compensation mechanism has a first rotation member and a second rotation member which are respectively capable of making two-DOF rotation, a first rotation of the first rotation member is yaw rotation, and a second rotation of the first rotation member is pitch rotation perpendicular to the first rotation, a third rotation and a fourth rotation of the second rotation member are respectively pitch rotation and roll rotation, and the robot arm comprises a single-DOF gravity compensator connected to the first rotation member or the second rotation member and offsetting the gravity caused by weight of the first rotation member or the second rotation member by using an elastic force of an elastic member.

### CROSS-REFERENCE TO RELATED APPLICATION

This application claims priority to Korean Patent Application No. 10-2012-0005264, filed on Jan. 17, 2012, and all the benefits accruing therefrom under 35 U.S.C. §119, the contents of which in its entirety are herein incorporated by reference.

### BACKGROUND

1. Field

The present disclosure relates to a robot arm having a weight compensation mechanism, and more particularly, to a robot arm having a weight compensation mechanism, which offsets the influence of gravity generated by a load of a multi-joint link mechanism.

2. Description of the Related Art

Recently, various kinds of robots are being developed for ensuring convenient life environments and helping works at industrial spots. In particular, robot arms utilized in various industrial fields such as painting and welding are being developed. For such an industrial multi-joint robot arm, it is important to generate so high torque to carry and support a heavy article.

The multi-joint robot arm receives a load torque due to its weight or a weight of a handled article, and this load torque gives a direct influence when designing a capacity of a driver such as a driving motor. In particular, in regard of the load applied to a driving motor, a torque component due to the weight of the robot arm occupies a considerable portion.

In case of determining a capacity of a driver of a conventional robot arm, since the gravity torque generated by the robot arm as well as the torque generated by a handled article should be considered, a power source for driving the robot arm should be designed to have a great capacity.

In addition, even though a simple idea having the concept of theoretically compensating the gravity caused by the weight of the robot arm has been proposed, a mechanism which practically applies such a theory has not been developed.

In this regard, the applicant has proposed a weight compensation mechanism in Korean Unexamined Patent No. 2011-0123012 and Korean Patent Application No. 2011-0045658, but the configuration and application of the weight compensation mechanism still have much room for improvement.

### RELATED LITERATURES

### Patent Literature

Patent Literature 1: Korean Unexamined Patent No. 2011-0123012
Patent Literature 2: Korean Patent Application No. 2011-0045658

### SUMMARY

The present disclosure is directed to providing a robot arm having a weight compensation mechanism, which may offset the influence of gravity caused by the weight of a link mechanism composed of multi Degree Of Freedom (DOF) joints.

In one aspect, there is provided a robot arm having a weight compensation mechanism, the weight compensation mechanism being installed at the robot arm having a first rotation member and a second rotation member which are respectively capable of making two-DOF rotation, wherein a first rotation of the first rotation member is yaw rotation, and a second rotation of the first rotation member is pitch rotation perpendicular to the first rotation, wherein a third rotation and a fourth rotation of the second rotation member are respectively pitch rotation and roll rotation, and wherein the robot arm comprises a single-DOF gravity compensator connected to the first rotation member or the second rotation member and offsetting the gravity caused by weight of the first rotation member or the second rotation member by using an elastic force of an elastic member.

One end of the single-DOF gravity compensator connected to the first rotation member may be connected to an output link of the first rotation, and the other end of the single-DOF gravity compensator may be fixed by the first rotation member serving as an output member of the first rotation and the second rotation.

The third rotation and the fourth rotation of the second rotation member may be restrained by a plurality of differential bevel gears.

Among the plurality of differential bevel gears, a single fixed bevel gear may be provided on a third rotary shaft, and the other rotation bevel gears may be attached on a fourth rotary shaft to be freely rotatable.

Among the differential bevel gears, a fixed bevel gear may be restricted by the second rotation of the first rotation member to move in parallel to the first rotation member serving as an output member of the first rotation and the second rotation.

Among the differential bevel gears, a single fixed bevel gear may be fixed to a rotating pulley which rotates on a third rotary shaft.

The robot arm may further include a rotating pulley rotating on a third rotary shaft and a fixed pulley located on a second rotary shaft and fixed to an output member of the first rotation.

The robot arm may further include a device for identically rotating the rotating pulley and the fixed pulley.

The device for identically rotating the rotating pulley and the fixed pulley may include timing belt pulleys respectively for the fixed pulley located at the second rotary shaft and the rotating pulley rotating on the third rotary shaft and connect the timing belt pulleys by a timing belt.

The device for identically rotating the rotating pulley and the fixed pulley may include wire pulleys respectively for the fixed pulley located at the second rotary shaft and the rotating pulley rotating on the third rotary shaft and connect the wire pulleys by a wire.

The device for identically rotating the rotating pulley and the fixed pulley may include rotation units respectively provided on the circumference of the fixed pulley located at the second rotary shaft and the circumference of the rotating pulley rotating on the third rotary shaft and connect the rotation units by a link.

One end of the single-DOF gravity compensator connected to the second rotation member may be fixed to a cam plate disposed at an outer side of a rotation bevel gear, and the other end of the single-DOF gravity compensator may be disposed in the second rotation member serving as an output member of the third rotation and the fourth rotation.

The single-DOF gravity compensator connected to the second rotation member may include: a spring having one end fixed to a spring fixing unit fixed to the second rotation member and the other end fixed to a sliding member moving along a guide bar attached to the spring fixing unit; and a wire having one end fixed to a rotatable connector provided at a cam plate and the other end fixed to the wire fixing unit fixed at the link member via an idle pulley fixed to the second member and a pulley provided in the sliding member, wherein the spring may be compressed when the sliding member moves toward the spring fixing unit.

The single-DOF gravity compensator connected to the first rotation member may include: a spring having one end fixed to the first rotation member rotating on the first rotary shaft and the second rotary shaft and the other end fixed to a sliding member moving along a guide bar attached to the spring fixing unit; and a wire having one end connected to a rotatable connector provided at the first rotation output link and the other end connected to the wire fixing unit fixed at the link member via an idle pulley fixed to the first member and a pulley provided in the sliding member, wherein the spring may be compressed when the sliding member moves toward the spring fixing unit.

The single-DOF gravity compensator connected to the first rotation member may include: a spring having one end fixed in a first rotation output link and the other end fixed to a sliding member moving along a guide bar attached to the spring fixing unit; and a wire having one end connected to a rotatable connector provided at the first rotation member rotating on the second rotary shaft and the other end connected to a wire fixing unit fixed to a link member via an idle pulley fixed at the first rotation output link and a pulley provided in the sliding member, wherein the spring may be compressed when the sliding member moves toward the spring fixing unit.

The pulley may be provided at a pulley fixing unit having a screw, be connected to the sliding member by using a bolt, and adjust a tension of the wire by rotating the bolt.

Four motors may be independently connected to make the first rotation, the second rotation, the third rotation and the fourth rotation of the first rotation member and the second rotation member.

The plurality of differential bevel gears may include a rotation bevel gear and a fixed bevel gear provided in the second rotation member.

The rotation bevel gear may be fixed on a third rotary shaft to be freely rotatable, and the other fixed bevel gear may be fixed on a fourth rotary shaft to the second rotation member which is an output of the third rotation and the fourth rotation.

The rotation bevel gear may be connected to a plurality of second rotating pulleys rotating on a third rotary shaft, provided in the second rotation member.

The robot arm may further include a plurality of first rotating pulleys rotating on a second rotary shaft and a plurality of second rotating pulleys rotating on a third rotary shaft.

A plurality of single-DOF gravity compensators may be connected to a plurality of first rotating pulleys which rotate on the second rotary shaft.

The robot arm may further include a device for identically rotating the first rotating pulley and the second rotating pulley.

The device for identically rotating the first rotating pulley and the second rotating pulley may include timing belt pulleys respectively for the first rotating pulley and the second rotating pulley and connect the timing belt pulleys by a timing belt.

The device for identically rotating the first rotating pulley and the second rotating pulley may include wire pulleys respectively for the first rotating pulley and the second rotating pulley and connect the wire pulleys by a wire.

The device for identically rotating the first rotating pulley and the second rotating pulley may include rotation units respectively provided on the circumference of the first rotating pulley and the circumference of the second rotating pulley and connect the rotation units by a link.

The robot arm having a weight compensation mechanism according to the present disclosure may greatly reduce the power of a power source used for driving the robot arm and various link members. Further, the reduced power brings the decrease of weight of the entire robot arm and the increase of driving efficiency, which results in energy saving.

In addition, since the robot arm having a weight compensation mechanism according to the present disclosure requires a relatively small driving force, production costs are reduced, which allows the development of products with price competitiveness.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a schematic view showing a robot arm having a weight compensation mechanism according to an embodiment of the present disclosure;

FIG. 2 is a schematic view showing a single-Degree Of Freedom (DOF) gravity compensator provided at the weight compensation mechanism according to an embodiment of the present disclosure;

FIG. 3 is a diagram showing a spring unit employed in the single-DOF gravity compensator;

FIG. 4 is a partial cross-sectional view showing a robot arm having a weight compensation mechanism according to an embodiment of the present disclosure; and

FIG. 5 is a partial cross-sectional view showing a robot arm having a weight compensation mechanism according to another embodiment of the present disclosure.

### DETAILED DESCRIPTION OF MAIN ELEMENTS

100: robot arm
101: first rotation member
102: second rotation member
103: base
110: first rotary shaft
111: second rotary shaft
112: third rotary shaft
113: fourth rotary shaft
201, 202: single-DOF gravity compensator
210, 220: rotation member
211, 221: rotary shaft
212, 222: wire connector
213, 223: idle pulley
214, 224: wire
215, 225: spring
216, 226: base
301: spring fixing unit
302: guide bar
303: sliding member
304: bolt
305: spring
306: pulley fixing unit
307: pulley
308: wire
410: fixed pulley
411: rotating pulley
412, 544, 545: timing belt
420, 510: differential bevel gear frame
430, 521, 531: fixed bevel gear
431, 520, 530: rotation bevel gear
432: cam plate
440: first rotation output member
540, 541: second rotating pulley
542, 543, 546: first rotating pulley

### DETAILED DESCRIPTION

Hereinafter, a robot arm having a weight compensation mechanism according to an embodiment of the present disclosure will be described in detail with reference to the accompanying drawings.

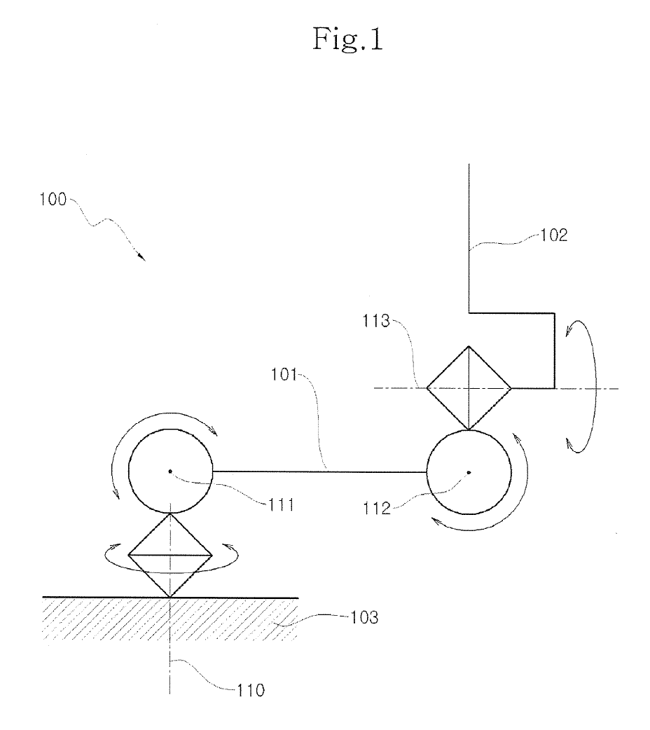

FIG. 1 is a schematic view showing a robot arm having a weight compensation mechanism according to an embodiment of the present disclosure.

Referring to FIG. 1, a robot arm 100 having a weight compensation mechanism according to an embodiment of the present disclosure includes a first rotation member 101 and a second rotation member 102 serving as a framework of the robot arm 100, and the first rotation member 101 is connected to a fixed base 103.

A first rotary shaft 110 and a second rotary shaft 111 intersecting each other are formed between the base 103 and the first rotation member 101, and a third rotary shaft 112 and a fourth rotary shaft 113 are formed between the first rotation member 101 and the second rotation member 102, respectively.

Therefore, in this embodiment, the first rotation member 101 of the robot arm 100 may make two-DOF rotation on the first rotary shaft 110 and the second rotary shaft 111 intersecting each other, and the second rotation member 102 of the robot arm 100 may make two-DOF rotation on the third rotary shaft 112 and the fourth rotary shaft 113 intersecting each other.

Hereinafter, operations of the robot arm 100 will be described. A first motor (not shown) for making a first rotation on the first rotary shaft 110 is mounted to the base 103, and a first output link (not shown) is connected to an output shaft of the first motor. In addition, a second motor is mounted to the first output link to make a second rotation on the second rotary shaft 111, and the first rotation member 101 is connected to an output shaft of the second motor. Therefore, if the first motor or the second motor rotates, the first rotation member 101 rotates on the first rotary shaft 110 or the second rotary shaft 111.

In addition, a third motor (not shown) is mounted to the first rotation member 101 to make a third rotation on the third rotary shaft 112, and a second output link (not shown) is connected to an output shaft of the third motor. Moreover, a fourth motor (not shown) is mounted to the second output link to make a fourth rotation on the fourth rotary shaft 113, and the second rotation member 102 is connected to an output shaft of the fourth motor. Therefore, if the third motor and the fourth motor operate, the second rotation member 102 rotates on the third rotary shaft 112 and the fourth rotary shaft 113.

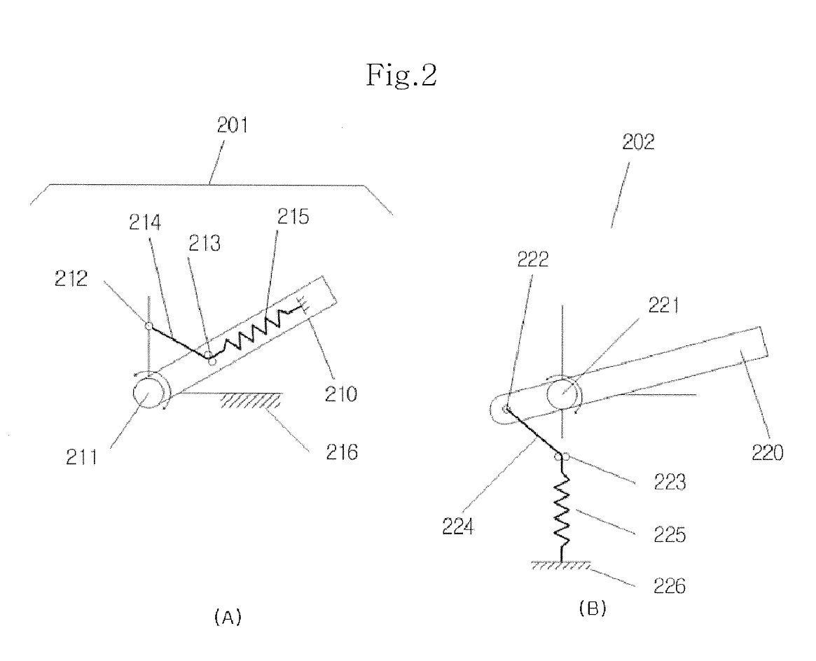

FIG. 2 is a schematic view showing a single-Degree Of Freedom (DOF) gravity compensator provided at the weight compensation mechanism according to an embodiment of the present disclosure.

Referring to FIG. 2, the single-DOF gravity compensator 201, 202 includes a spring 215, 225 for storing elastic energy, a wire 214, 224, an idle pulley 213, 223 and a wire connector 212, 222.

First, the single-DOF gravity compensator 201 where the spring 215 is provided at the rotation member 210 as shown in Portion (A) of FIG. 2 will be described. One end of the spring 215 is fixed to the rotation member 210, and the other end is connected to the wire 214. The wire 214 is fixed via the idle pulley 213 fixed at the rotation member 210 to the wire connector 212 rotatably fixed at the base 216.

Subsequently, the single-DOF gravity compensator 202 where the spring 225 is provided at the base 226 as shown in Portion (B) of FIG. 2 will be described. One end of the spring 225 is fixed to the base 226, and the other end is connected to the wire 224. The wire 224 is fixed via the idle pulley 223 fixed at the base 226 to the wire connector 222 rotatably fixed at the rotation member 220.

Operations of the single-DOF gravity compensators 201, 202 will be described. If the rotation member 210, 220 rotates on the rotary shaft 211, 221, the wire 214, 224 is pulled, and accordingly the spring 215, 225 stretches to generate elastic energy.

Even though a tension spring is applied in FIG. 2, a compression spring may also be used.

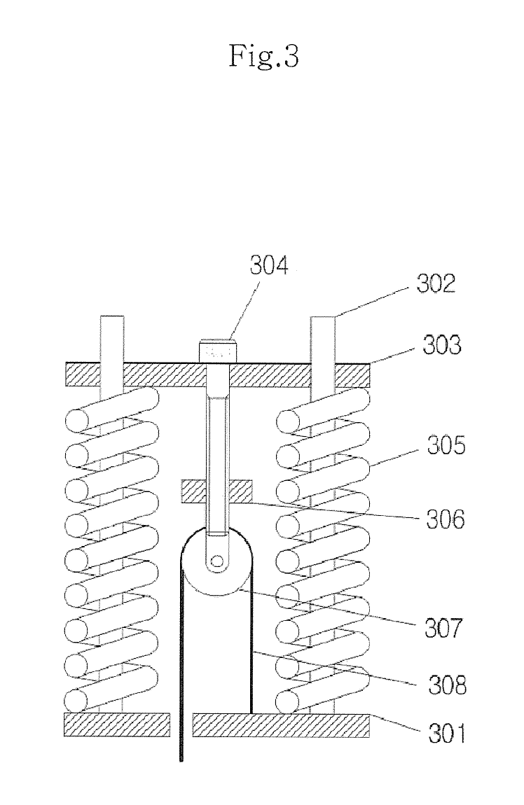

FIG. 3 is a diagram showing a spring unit employed in the single-DOF gravity compensator.

Referring to FIG. 3, one end of a plurality of springs 305 is fixed to a spring fixing unit 301 fixed to the base, and the other end of the plurality of springs 305 is fixed to a sliding member 303 moving along a guide bar 302 installed at the spring fixing unit 301. Therefore, if the sliding member 303 moves toward the spring fixing unit 301, the spring 305 is compressed.

One end of the steel wire 308 is fixed to the wire connector 212, 222 shown in FIG. 2 and fixed to the spring fixing unit 301 via the idle pulley 213, 223 and the pulley 307.

The pulley 307 is fixed to the pulley fixing unit 306. The pulley fixing unit 306 has a screw, and the sliding member 303 has a through hole so that a bolt 304 is inserted into the sliding member 303 and couples the pulley fixing unit 306 and the pulley fixing unit 306. Therefore, if the bolt 304 is fastened, the sliding member 303 moves toward the spring fixing unit 301, and so the spring 305 is compressed and adjusts a tension.

Even though this embodiment adopts a coil spring, the present disclosure is not limited thereto, and the coil spring may be modified into various elastic members such as a leaf spring. In addition, even though two guide bars 302 and two springs 305 are installed in this embodiment, the number of these components may be changed in various ways. Moreover, even though a steel wire 308 is used in this embodiment to make a spring displacement, a coil spring may be provided in a cylinder so that one end of the cylinder is connected to a rotatable connector 211, 221 and the other end is rotatably fixed to the idle pulley 213, 223.

Even though a spring, a wire and a pulley is used in this embodiment to compensate gravity, the present disclosure is not limited thereto, and various kinds of single-DOF gravity compensators may be alternatively used, for example a single-DOF gravity compensator having cam profiles at inner and outer sides thereof. In an alternative configuration, one end of the single-DOF gravity compensator may be connected to the rotation member 210, 220, and the other end serving as an output may be fixed to the base 216, 226. In other case, one end of the single-DOF gravity compensator may be fixed to the base 216, 226, and the other end serving as an output may be fixed to the rotation member 210, 220.

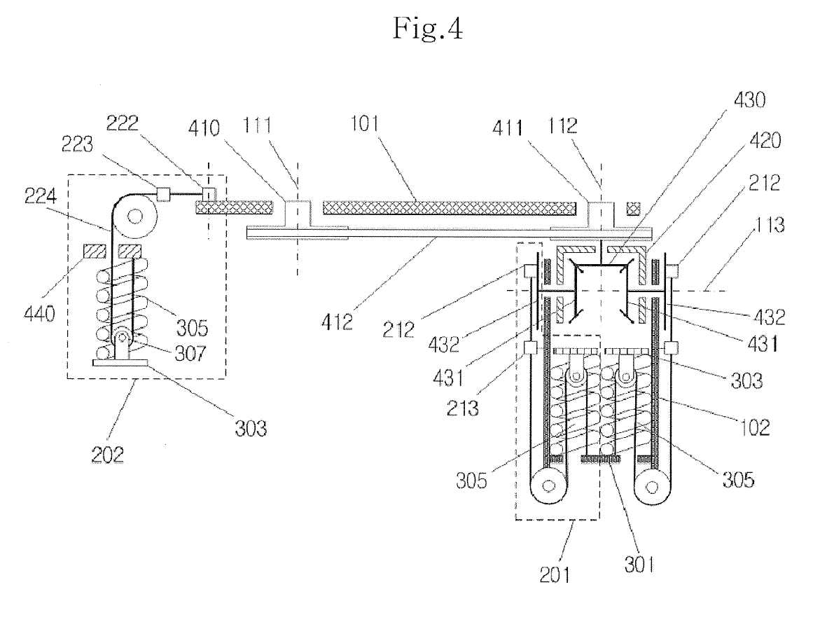

FIG. 4 is a partial cross-sectional view showing a robot arm having a weight compensation mechanism according to an embodiment of the present disclosure, which is depicted based on an output link of the first rotation. In other words, components corresponding to the base 103 and the first rotary shaft 110 are not depicted in FIG. 4.

Referring to FIG. 4, the robot arm includes a differential bevel gear composed of a fixed bevel gear 430 and a rotation bevel gear 431, a differential bevel gear frame 420, a cam plate 432, a fixed pulley 410, a rotating pulley 411, and single-DOF gravity compensators 201, 202.

The differential bevel gear frame 420 is rotatably provided on the third rotary shaft 112. The fixed bevel gear 430 is provided in the differential bevel gear frame 420 and is installed to be rotatable on the third rotary shaft 112. In addition, the rotation bevel gear 431 is provided in the differential bevel gear frame 420 and is installed to be rotatable on the fourth rotary shaft 113.

Both cam plates 432 are connected and fixed to the rotation bevel gear 431 along a shaft formed through holes respectively formed in the second rotation member 102 and the differential bevel gear frame 420. Therefore, the rotation bevel gear 431 and the cam plate 432 rotate identically and may freely rotate with respect to the second rotation member 102 and the differential bevel gear frame 420.

The wire connector 212 is provided at the side of the cam plate 432, and the wire 214 of the single-DOF gravity compensator 201 is connected thereto. At this time, one end of the single-DOF gravity compensator 201 is fixed to the wire connector 212, the other end is located in the second rotation member 102, and the spring fixing unit 301 is provided at the second rotation member 102.

The fixed pulley 410 is provided to one end of the first rotation member 101, and the rotating pulley 411 is provided to the other end of the first rotation member 101, respectively. In addition, the fixed pulley 410 is disposed on the second rotary shaft 111 and fixed to an output member 440 of the first rotation, and the rotating pulley 411 is provided to be rotatable on the third rotary shaft 112. Here, even though it is illustrated as if the fixed pulley 410 and the output member 440 are separated, the fixed pulley 410 is fixed to one surface of the output member 440.

The fixed pulley 410 and the rotating pulley 411 are configured to rotate identically. In other words, the rotating pulley 411 located at the other end of the first rotation member 101 may rotate by the fixed pulley 410 located at one end of the first rotation member 101. In other case, the rotating pulley 411 located at the other end of the first rotation member 101 may rotate by the first rotation member 101 in a state where the fixed pulley 410 located at one end of the first rotation member 101 is fixed. For this, timing belt teeth are respectively provided on the circumferences of the fixed pulley 410 and the rotating pulley 411 located at both ends of the first rotation member 101, and the fixed pulley 410 and the rotating pulley 411 provided at both sides of the first rotation member 101 as shown in FIG. 4 are connected by a timing belt 412.

Even though the fixed pulley 410 and the rotating pulley 411 provided at both sides of the first rotation member 101 are connected by a timing belt in this embodiment, it is also possible that the pulleys 410, 411 have wire grooves to make a connection by using a steel wire. In addition, rotation units may be configured at sides of the pulleys 410, 411, respectively, and connected by a link.

The fixed bevel gear 430 of the differential bevel gear is fixed to the rotating pulley 411. Therefore, the fixed bevel gear 430 rotates identical to the rotating pulley 411.

The wire connector 222 is provided at the side of the first rotation member 101, and the wire 224 of the single-DOF gravity compensator 202 is connected thereto. At this time, one end of the single-DOF gravity compensator 202 is fixed to the wire connector 222, the other end is located in the output member 440 of the first rotation, and the spring fixing unit is provided at the output member 440 of the first rotation.

An example of a motor arrangement has been described with reference to FIG. 1, and another example of a motor arrangement will be described below even though it is not depicted in the figures.

The first rotation and the second rotation of the first rotation member 101 on the first rotary shaft 110 and the second rotary shaft 111 are respectively driven by the first motor and the second motor. In addition, the third rotation and the fourth rotation of the second rotation member 102 on the third rotary shaft 112 and the fourth rotary shaft 113 are driven by the third motor and the fourth motor. Here, the fourth motor is provided between the differential bevel gear frame 420 and the second rotation member 102. In addition, four motors may be independently provided to make the first rotation, the second rotation, the third rotation and the fourth rotation of the first rotation member 101 and the second rotation member 102.

Moreover, for the connection of the third motor and the fourth motor, it is possible that a gear is provided at the circumference of the cam plate 432 and is connected to a pinion gear, a timing belt pulley fixed to the pinion gear is installed, and then the third motor fixed to the second rotation member 102 is connected to a timing belt pulley fixed to the shaft of the fourth motor by means of a timing belt, thereby connecting the third motor and the fourth motor. The power transmission method for driving the cam plate 432 by using the third motor and the fourth motor as described in this embodiment is just an example, and the present disclosure is not limited thereto.

Hereinafter, operations of the robot arm shown in FIG. 4 will be described.

First, if the first rotary shaft 110 of FIG. 1 is parallel to the gravity direction, even though the first rotation member 101 makes the first rotation, the torque applied to the first rotary shaft 110 does not change. Therefore, the compensation of gravity with respect to the first rotation of the first rotation member 101 will not be considered.

Meanwhile, if the first rotation member 101 rotates on the second rotary shaft 111, the wire connector 222 moves to pull the wire 224. The wire 224 pulls the sliding member 303 toward the output member 440 by means of the pulley 307 to compress the spring 305. The compressed force of the spring 305 offsets the gravity caused by the weight of the robot arm 100. Therefore, even though the robot arm 100 rotates by a predetermined angle on the second rotary shaft 111, the robot arm 100 does not move downwards by gravity any more and may maintain its posture like a gravity-free state. Here, the rotating pulley 411 moves in parallel to the output member 440 of the first rotation while rotating in a direction opposite to the rotating direction of the first rotation member 101.

Next, the first rotation member 101 is fixed, and the second rotation member 102 rotates on the third rotary shaft 112. In this case, the rotating pulley 411 is fixed, and the fixed bevel gear 430 is also fixed identically. Since the fourth rotary shaft 113 is formed through the second rotation member 102, the differential bevel gear frame 420 rotates identical to the second rotation member 102. In this state, the right and left rotation bevel gears 431 rotate in opposite directions, and relatively rotate with respect to the second rotation member 102. In addition, the right and left cam plates 432 also make the same relative rotations with respect to the second rotation member 102. Accordingly, the wire connector 212 also moves to compress the spring 305 while pulling and releasing the wire 214. The compressed force of the spring 305 offsets the gravity caused by the weight of the robot arm 100. Therefore, even though the robot arm 100 rotates by a predetermined angle on the third rotary shaft 112, the robot arm 100 does not move downwards by gravity any more and may maintain its posture like a gravity-free state.

Next, the first rotation member 101 is fixed, and the second rotation member 102 rotates on the fourth rotary shaft 113. In this case, the rotating pulley 411 is fixed, and the fixed bevel gear 430 is also fixed identically. Since the fourth rotary shaft 113 is formed through the second rotation member 102, the differential bevel gear frame 420 is fixed, and only the second rotation member 102 rotates. Therefore, the right and left rotation bevel gears 431 are fixed, and therefore, the right and left cam plates 432 are also fixed identically. This means that the wire connector 212 is fixed. The second rotation member 102 relatively rotates with respect to the rotation bevel gear 431 or the cam plate 432 by means of the driving of the fourth motor mounted between the differential bevel gear frame 420 and the second rotation member 102.

Accordingly, the idle pulley 213 fixed to the second rotation member 102 moves to pull the wire 214 and compress the spring 305. The compressed force of the spring 305 offsets the gravity caused by the weight of the robot arm 100. Therefore, even though the robot arm 100 rotates by a predetermined angle on the fourth rotary shaft 113, the robot arm 100 does not move downwards by gravity any more and may maintain its posture like a gravity-free state.

Meanwhile, the elastic modulus of the spring 305 may be appropriately designed in consideration of the weight, length or the like of the robot arm 100.

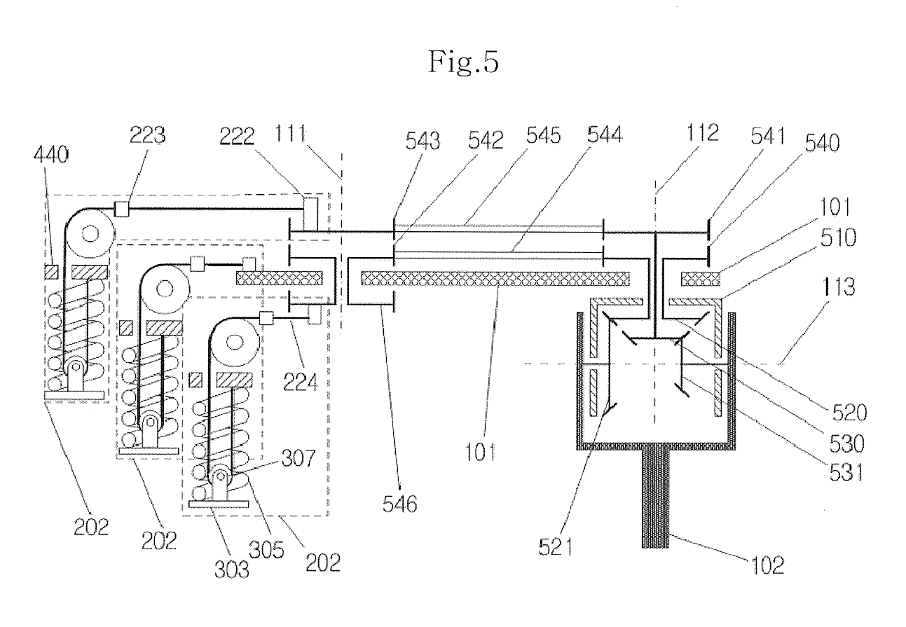

FIG. 5 is a partial cross-sectional view showing a robot arm having a weight compensation mechanism according to another embodiment of the present disclosure, depicted based on an output link of the first rotation. In other words, components corresponding to the base 103 and the first rotary shaft 110 are not depicted in FIG. 5.

Referring to FIG. 5, the robot arm includes two differential bevel gears composed of fixed bevel gears 521, 531 and rotation bevel gears 520, 530, a differential bevel gear frame 510, first rotating pulleys 542, 543, 546, second rotating pulleys 540, 541 and three single-DOF gravity compensators 202.

The differential bevel gear frame 510 is provided to be rotatable on the third rotary shaft 112. The fixed bevel gears 521, 531 are provided in the differential bevel gear frame 510, are installed along the fourth rotary shaft 113, and are fixed to the second rotation member 102. In addition, the rotation bevel gears 520, 530 are provided in the differential bevel gear frame 510 and are installed to be rotatable on the third rotary shaft 112. The differential bevel gear frame 510 has a hole and a bearing in the direction of the third rotary shaft 112, and the shaft of the first rotation bevel gear 520 is connected to the second rotating pulley 540 through the differential bevel gear frame 510. In addition, the shaft of the first rotation bevel gear 520 has a hole and a bearing, and the shaft of the second rotation bevel gear 530 is connected to the second rotating pulley 541 through the shaft of the first rotation bevel gear 520. Therefore, the first rotation bevel gear 520 and the second rotation bevel gear 530 may make free rotation with respect to the differential bevel gear frame 420 and the first rotation member 101.

The second rotating pulleys 540, 541 are respectively fixed to the shafts of the first rotation bevel gear 520 and the second rotation bevel gear 530. Therefore, the second rotating pulleys 540, 541 rotate identical to the rotation bevel gears 520, 530.

The first rotating pulleys 542, 543, 546 are rotatably disposed on the second rotary shaft 111. The first rotating pulley 542 and the first rotating pulley 546 are connected to each other through the shaft formed through the first rotation member 101. Therefore, the first rotating pulley 542 and the first rotating pulley 546 make the same rotation.

Timing belt teeth are respectively provided at the circumferences of the first rotating pulleys 542, 543 and the second rotating pulleys 540, 541, and the first rotating pulleys 542, 543 and the second rotating pulleys 540, 541 are connected by using timing belts 544, 545 as shown in FIG. 5.

Even though the first rotating pulleys 542, 543 and the second rotating pulleys 540, 541 provided at both sides of the first rotation member 101 are connected by using the timing belts 544, 545, it is also possible that the first rotating pulleys 542, 543 and the second rotating pulleys 540, 541 have wire grooves to be connected by steel wires. In addition, it is also possible that rotation units are respectively provided at sides of the first rotating pulleys 542, 543 and the second rotating pulleys 540, 541 and connected by using links.

The wire connector 222 is provided at the side of the first rotation member 101, and the wire 224 of the single-DOF gravity compensator 202 is connected thereto. The wire 224 is fixed to the output member 440 of the first rotation through the idle pulley 223 fixed to the output member 440 of the first rotation and the pulley 307 provided at the sliding member 303 disposed in the output member 440.

The wire connector 222 is also provided at the sides of the first rotating pulleys 542, 546, and the wire 224 of the single-DOF gravity compensator 202 is connected thereto. The wire 224 is fixed to the output member 440 of the first rotation through the idle pulley 223 fixed to the output member 440 of the first rotation and the pulley 307 provided at the sliding member 303 disposed in the output member 440.

Hereinafter, an embodiment of a motor arrangement, different from that of FIG. 1 as described above, will be described.

The first rotation member 101 rotates on the first rotary shaft 110 and the second rotary shaft 111 by the driving of the first motor and the second motor. In addition, for the third rotation and the fourth rotation, the third motor and the fourth motor are provided at the output member 440 of the first rotation. For the connection of the third motor and the fourth motor, it is possible that gears are provided at the circumferences of the first rotating pulleys 542, 543 and connected to a pinion gear, a timing belt pulley fixed to the pinion gear is installed, and then the third motor fixed to the output member 440 of the first rotation is connected to the timing belt pulley fixed to the shaft of the fourth motor by using a timing belt, so that the third motor and the fourth motor are connected. The power transmission method for driving the first rotating pulleys 542, 543 by using the third motor and the fourth motor as described in this embodiment is just an example, and the present disclosure is not limited thereto.

Hereinafter, operations of the robot arm shown in FIG. 5 will be described.

First, if the first rotary shaft 110 of FIG. 1 is parallel to the gravity direction, even though the first rotation member 101 makes the first rotation, the torque applied to the first rotary shaft 110 does not change. Therefore, the compensation of gravity with respect to the first rotation of the first rotation member 101 will not be considered.

If the first rotation member 101 rotates on the second rotary shaft 111 in a state where the first rotating pulleys 542, 543, 546 are fixed, the wire connector 222 moves to pull the wire 224. The wire 224 pulls the sliding member 303 toward the output member 440 by means of the pulley 307 to compress the spring 305. The compressed force of the spring 305 offsets the gravity caused by the weight of the robot arm 100. Therefore, even though the robot arm 100 rotates by a predetermined angle on the second rotary shaft 111, the robot arm 100 does not move downwards by gravity any more and may maintain its posture like a gravity-free state. Here, the second rotating pulleys 540, 541 moves in parallel to the output member 440 of the first rotation while rotating in a direction opposite to the rotating direction of the first rotation member 101.

Next, the first rotation member 101 is fixed, and the second rotation member 102 rotates on the third rotary shaft 112. Since the fourth rotary shaft 113 is formed through the second rotation member 102, the differential bevel gear frame 510 rotates identical to the second rotation member 102. Therefore, the rotation bevel gears 520, 530 engaged with the fixed bevel gears 521, 531 fixed to the second rotation member 102 rotate identical to the second rotation member 102, and the second rotating pulleys 540, 541 connected to the rotation bevel gears 520, 530 also make the same rotation. In addition, due to the rotation of the second rotating pulleys 540, 541, the first rotating pulleys 542, 543, 546 also make the same rotation. Accordingly, the wire connector 222 fixed to the first rotating pulleys 543, 546 also moves to pull or release the wire 224, thereby compressing the spring 305. The compressed force of the spring 305 offsets the gravity caused by the weight of the robot arm 100. Therefore, even though the robot arm 100 rotates by a predetermined angle on the third rotary shaft 112, the robot arm 100 does not move downwards by gravity any more and may maintain its posture like a gravity-free state.

Next, the first rotation member 101 is fixed, and the second rotation member 102 rotates on the fourth rotary shaft 113. Since the fourth rotary shaft 113 is formed through the second rotation member 102, the differential bevel gear frame 510 is fixed, and only the second rotation member 102 rotates on the fourth rotary shaft 113. In other words, the fixed bevel gears 521, 531 fixed to the second rotation member 102 rotate toward the fourth rotary shaft. Therefore, the rotation bevel gears 520, 530 engaged with the fixed bevel gears 521, 531 fixed to the second rotation member 102 rotate in opposite directions, and the second rotating pulleys 540, 541 connected to the rotation bevel gears 520, 530 also rotate in opposite directions.

In addition, due to the rotation of the second rotating pulleys 540, 541, the first rotating pulleys 543, 542, 546 rotate in opposite directions. Accordingly, the wire connector 222 fixed at the first rotating pulleys 543, 546 moves to pull or release the wire 224, thereby compressing the spring 305. The compressed force of the spring 305 offsets the gravity caused by the weight of the robot arm 100. Therefore, even though the robot arm 100 rotates by a predetermined angle on the fourth rotary shaft 113, the robot arm 100 does not move downwards by gravity any more and may maintain its posture like a gravity-free state.

Even though the fixed bevel gears 521, 531 are disposed at right and left sides of the third rotary shaft 112 in this embodiment, the fixed bevel gears 521, 531 may also be disposed at only one side of the third rotary shaft 112.

Meanwhile, the elastic modulus of the spring 305 may be appropriately designed in consideration of the weight, length or the like of the robot arm 100.

While the exemplary embodiments have been shown and described, it will be understood by those skilled in the art that various changes in form and details may be made thereto without departing from the spirit and scope of the present disclosure as defined by the appended claims.

1. A robot arm having a weight compensation mechanism, the weight compensation mechanism being installed at the robot arm having a first rotation member and a second rotation member which are respectively capable of making two-Degree Of Freedom (DOF) rotation,
wherein a first rotation of the first rotation member is yaw rotation, and a second rotation of the first rotation member is pitch rotation perpendicular to the first rotation,
wherein a third rotation and a fourth rotation of the second rotation member are respectively pitch rotation and roll rotation, and
wherein the robot arm comprises a single-DOF gravity compensator connected to the first rotation member or the second rotation member and offsetting the gravity caused by weight of the first rotation member or the second rotation member by using an elastic force of an elastic member.

2. The robot arm having a weight compensation mechanism according to claim 1,
wherein one end of the single-DOF gravity compensator connected to the first rotation member is connected to an output member of the first rotation, and the other end of the single-DOF gravity compensator is fixed by the first rotation member which makes the first rotation and the second rotation.

3. The robot arm having a weight compensation mechanism according to claim 1,
wherein the third rotation and the fourth rotation of the second rotation member are restrained by a plurality of differential bevel gears.

4. The robot arm having a weight compensation mechanism according to claim 3,
wherein, among the plurality of differential bevel gears, a single fixed bevel gear is provided on a third rotary shaft, and the other rotation bevel gears are installed on a fourth rotary shaft to be freely rotatable.

5. The robot arm having a weight compensation mechanism according to claim 3,
wherein, among the differential bevel gears, a fixed bevel gear is restricted by the second rotation of the first rotation member to move in parallel to an output member of the first rotation.

6. The robot arm having a weight compensation mechanism according to claim 3,
wherein, among the differential bevel gears, a single fixed bevel gear is fixed to a rotating pulley which rotates on a third rotary shaft.

7. The robot arm having a weight compensation mechanism according to claim 1, further comprising:
a rotating pulley rotating on a third rotary shaft; and
a fixed pulley located on a second rotary shaft and fixed to an output member of the first rotation.

8. The robot arm having a weight compensation mechanism according to claim 7, further comprising a device for identically rotating the rotating pulley and the fixed pulley.

9. The robot arm having a weight compensation mechanism according to claim 8,
wherein the device for identically rotating the rotating pulley and the fixed pulley includes timing belt pulleys respectively for the fixed pulley located at the second rotary shaft and the rotating pulley rotating on the third rotary shaft and connects the timing belt pulleys by a timing belt.

10. The robot arm having a weight compensation mechanism according to claim 8,
wherein the device for identically rotating the rotating pulley and the fixed pulley includes wire pulleys respectively for the fixed pulley located at the second rotary shaft and the rotating pulley rotating on the third rotary shaft and connects the wire pulleys by a wire.

11. The robot arm having a weight compensation mechanism according to claim 8,
wherein the device for identically rotating the rotating pulley and the fixed pulley includes rotation units respectively provided on the circumference of the fixed pulley located at the second rotary shaft and the circumference of the rotating pulley rotating on the third rotary shaft and connects the rotation units by a link.

12. The robot arm having a weight compensation mechanism according to claim 1,
wherein one end of the single-DOF gravity compensator connected to the second rotation member is fixed to a cam plate disposed at an outer side of a rotation bevel gear, and the other end of the single-DOF gravity compensator is disposed in the second rotation member.

13. The robot arm having a weight compensation mechanism according to claim 1, wherein the single-DOF gravity compensator connected to the second rotation member includes:
a spring having one end fixed to a spring fixing unit fixed to the second rotation member and contacting a sliding member moving along a guide bar attached to the spring fixing unit; and
a wire having one end connected to a rotatable wire connector provided at a cam plate and the other end fixed in the second rotation member via an idle pulley and a pulley fixed at the second rotation member,
wherein the spring is compressed when the sliding member moves toward the spring fixing unit.

14. The robot arm having a weight compensation mechanism according to claim 1, wherein the single-DOF gravity compensator connected to the first rotation member includes:
a spring having one end fixed in an output member of the first rotation and contacting a sliding member moving along a guide bar attached to the spring fixing unit; and
a wire having one end connected to a wire connector of the first rotation member and the other end fixed in the output member of the first rotation via an idle pulley and a pulley fixed at the first rotation member,
wherein the spring is compressed when the sliding member moves toward the spring fixing unit.

15. The robot arm having a weight compensation mechanism according to claim 13,
wherein the pulley is provided at a pulley fixing unit having a screw, is connected to the sliding member by using a bolt, and adjusts a tension of the wire by rotating the bolt.

16. The robot arm having a weight compensation mechanism according to claim 1,
wherein four motors are independently connected to make the first rotation, the second rotation, the third rotation and the fourth rotation of the first rotation member and the second rotation member.

17. The robot arm having a weight compensation mechanism according to claim 3,
wherein the plurality of differential bevel gears include a rotation bevel gear and a fixed bevel gear provided in the second rotation member.

18. The robot arm having a weight compensation mechanism according to claim 17,
wherein the rotation bevel gear is fixed on a third rotary shaft to be freely rotatable, and the other fixed bevel gear is fixed on a fourth rotary shaft to the second rotation member which is an output of the third rotation and the fourth rotation.

19. The robot arm having a weight compensation mechanism according to claim 17,
wherein the rotation bevel gear is connected through the second rotation member to a plurality of second rotating pulleys which rotate on a third rotary shaft.

20. The robot arm having a weight compensation mechanism according to claim 1, further comprising:
a plurality of first rotating pulleys rotating on a second rotary shaft; and
a plurality of second rotating pulleys rotating on a third rotary shaft.

21. The robot arm having a weight compensation mechanism according to claim 20,
wherein a plurality of single-DOF gravity compensators are connected to a plurality of first rotating pulleys which rotate on the second rotary shaft.

22. The robot arm having a weight compensation mechanism according to claim 20, further comprising a device for identically rotating the first rotating pulley and the second rotating pulley.

23. The robot arm having a weight compensation mechanism according to claim 22,
wherein the device for identically rotating the first rotating pulley and the second rotating pulley includes timing belt pulleys respectively for the first rotating pulley and the second rotating pulley and connects the timing belt pulleys by a timing belt.

24. The robot arm having a weight compensation mechanism according to claim 22,
wherein the device for identically rotating the first rotating pulley and the second rotating pulley includes wire pulleys respectively for the first rotating pulley and the second rotating pulley and connects the wire pulleys by a wire.

25. The robot arm having a weight compensation mechanism according to claim 22,
wherein the device for identically rotating the first rotating pulley and the second rotating pulley includes rotation units respectively provided on the circumference of the first rotating pulley and the circumference of the second rotating pulley and connects the rotation units by a link.

26. The robot arm having a weight compensation mechanism according to claim 14,
wherein the pulley is provided at a pulley fixing unit having a screw, is connected to the sliding member by using a bolt, and adjusts a tension of the wire by rotating the bolt.
